(19) United States
(12) Patent Application Publication
(10) Pub. No.: US 2021/0192467 A1
(43) Pub. Date: Jun. 24, 2021

(54) RECURRING MEETING SCHEDULING

(71) Applicant: Lenovo (Singapore) Pte. Ltd., Singapore (SG)

(72) Inventors: Russell Speight VanBlon, Raleigh, NC (US); Philip L. Childs, Fort Wayne, IN (US); Jonathan Co Lee, Cary, NC (US)

(21) Appl. No.: 16/724,932

(22) Filed: Dec. 23, 2019

(51) Int. Cl. G06Q 10/10; H04L 12/18

(52) U.S. Cl. CPC G06Q 10/1095; H04L 12/1818

(57) ABSTRACT

One embodiment provides a method, including: receiving, at an information handling device, one or more meeting parameters corresponding to a recurring meeting and provided by a user; accessing a schedule for each of a plurality of attendees and a schedule for possible meeting locations for the recurring meeting; and based upon the one or more meeting parameters, the schedule for each of the plurality of attendees, and the possible meeting locations, scheduling times and locations for each recurrence of the recurring meeting. Other aspects are described and claimed.

### BACKGROUND

On busy days, organization of a person's schedule can become critical. Fitting multiple meetings, events, and the like, into a single work day requires time and strategy. When scheduling a meeting, an organizer has to take into account multiple meeting parameters, such as time, location, recurrence, and the like. With each potential attendee of the meeting having an individual schedule, figuring out a time that works with each attendees' schedule can be a time-consuming nuisance. Additionally, when a meeting needs to be a recurring meeting, the parameters and difficulty scheduling the meeting and all the recurrences is increased. Individual schedules for other variable meeting parameters, such as meeting location availability, can cause similar scheduling issues.

### BRIEF SUMMARY

In summary, one aspect provides a method, comprising: receiving, at an information handling device, one or more meeting parameters corresponding to a recurring meeting and provided by a user; accessing a schedule for each of a plurality of attendees and a schedule for possible meeting locations for the recurring meeting; and based upon the one or more meeting parameters, the schedule for each of the plurality of attendees, and the possible meeting locations, scheduling times and locations for each recurrence of the recurring meeting.

Another aspect provides an electronic device, comprising: a wireless charger integrated into the electronic device; a processor; a memory device that stores instructions executable by the processor to: receive, at an information handling device, one or more meeting parameters corresponding to a recurring meeting and provided by a user; access a schedule for each of a plurality of attendees and a schedule for possible meeting locations for the recurring meeting; and based upon the one or more meeting parameters, the schedule for each of the plurality of attendees, and the possible meeting locations, schedule times and locations for each recurrence of the recurring meeting.

A further aspect provides a product, comprising: a storage device that stores code, the code being executable by a processor and comprising: code that receives one or more meeting parameters corresponding to a recurring meeting and provided by a user; code that accesses a schedule for each of a plurality of attendees and a schedule for possible meeting locations for the recurring meeting; and code that, based upon the one or more meeting parameters, the schedule for each of the plurality of attendees, and the possible meeting locations, schedules times and locations for each recurrence of the recurring meeting.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of scheduling a recurring meeting around potential scheduling issues.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Consistently scheduling recurring meetings is difficult because of varying attendees' schedules, as well as availability of meeting locations and other necessary variable meeting parameters. In other words, finding a single meeting location, meeting time, and meeting day can be very difficult with individual schedules, meeting location schedules, and the like. Conventionally, using digital calendars and other forms of digital scheduling programs, a user attempting to schedule a recurring meeting will spend a great deal of time attempting to organize schedules and meeting locations. Conventional scheduling programs require a user to input distinct meeting parameters for a desired recurring meeting causing the extended organization time. Varying attendees' availability can cause recurring meetings to rarely occur at the same time each week, thus causing the meeting organizer to spend more researching and scheduling meetings.

Meeting locations can also become variable based on the availability. Meeting areas are commonly shared between everyone present in a work environment, thus room availability can be scarce, particularly during a specific times throughout a day, (e.g., late morning, early afternoon, etc.). The room availability may be particularly difficult when some meeting rooms can only accommodate so many people, which may be less than the number of meeting attendees. With distinct meeting parameters being used throughout conventional scheduling programs, a lack of adjustment and compensation of potential meeting parameters may result in many meeting scheduling conflicts, particularly with recurring meetings. Thus, scheduling recurring meetings becomes very difficult and time-consuming. Frequently, a meeting organizer will only schedule a few of the recurring meetings at a time in order to prevent having to sort through all of the recurrences and find times and locations that work for all the meeting attendees. This results in the meeting organizer having to perform the same exercise frequently every time the recurring meeting occurrences have to be extended.

Accordingly, an embodiment provides a method for dynamically scheduling recurring meetings based upon meeting parameters. A system and method may utilize meeting parameters, which may include flexible meeting parameters, to permit a system to schedule a meeting that is similar to the desired meeting parameters, but adjusted to account for each attendees' schedules, room availability, and any additional variable meeting parameter that may influence the scheduling of a meeting. Using the meeting parameters may further permit a system to successfully schedule all or most of the recurrences of the recurring meetings, even if the schedule for each of the recurrences is different from other recurrences.

Since a system is able to determine when the best time, location, and the like, for a single meeting is to occur, adding a flexible meeting parameter describing a recurrence variable input may allow for successfully scheduling future meetings. A flexible meeting parameter may be a meeting parameter inputs that is less specific as compared to conventional methods. Allowing for flexibility in the meeting parameters allows the system to optimize the scheduling of the recurrences of the meeting. In an embodiment, a system may present a user with an outline of the recurrence schedules prior to scheduling the meeting for all attendees. An embodiment may even present a user with multiple workable meetings that fall within the user inputs. Thus, a system and method may overcome meeting schedule conflicts, as well as provide a technique for successfully scheduling recurring meetings while decreasing the difficulty associated with scheduling each recurrence of a recurring meeting.

The illustrated example embodiments will be best understood by reference to the figures. The following description is intended only by way of example, and simply illustrates certain example embodiments.

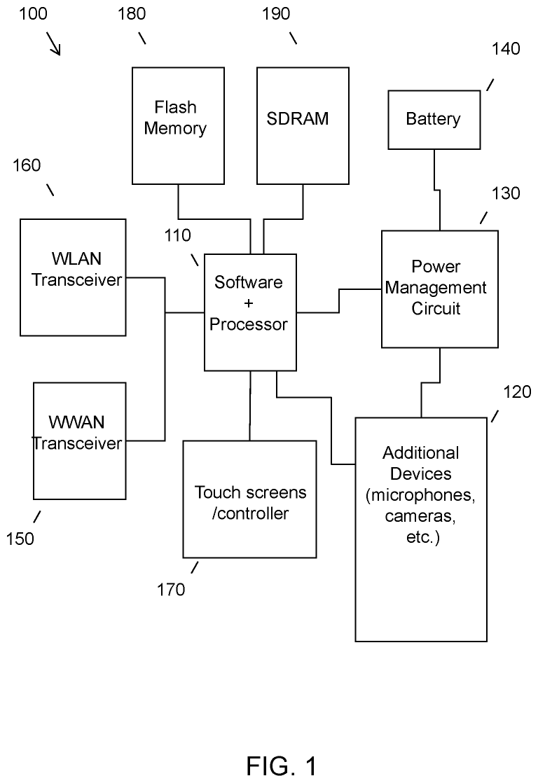

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

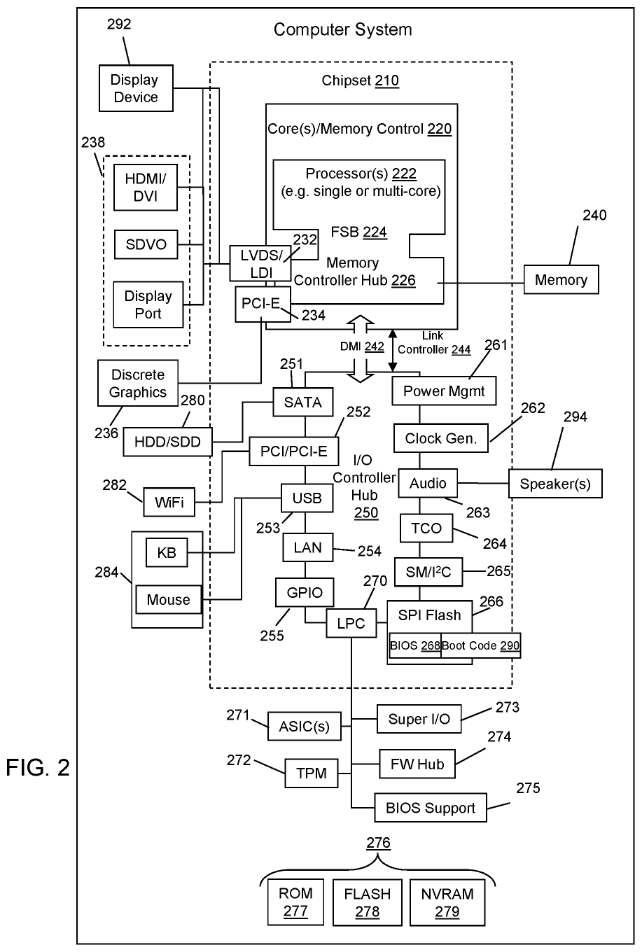

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in information handling devices that are utilized for scheduling recurring meetings or that include digital assistants that can be utilized to assist in scheduling recurring meetings. For example, the circuitry outlined in FIG. 1 may be implemented in a laptop embodiment, whereas the circuitry outlined in FIG. 2 may be implemented in another computing source.

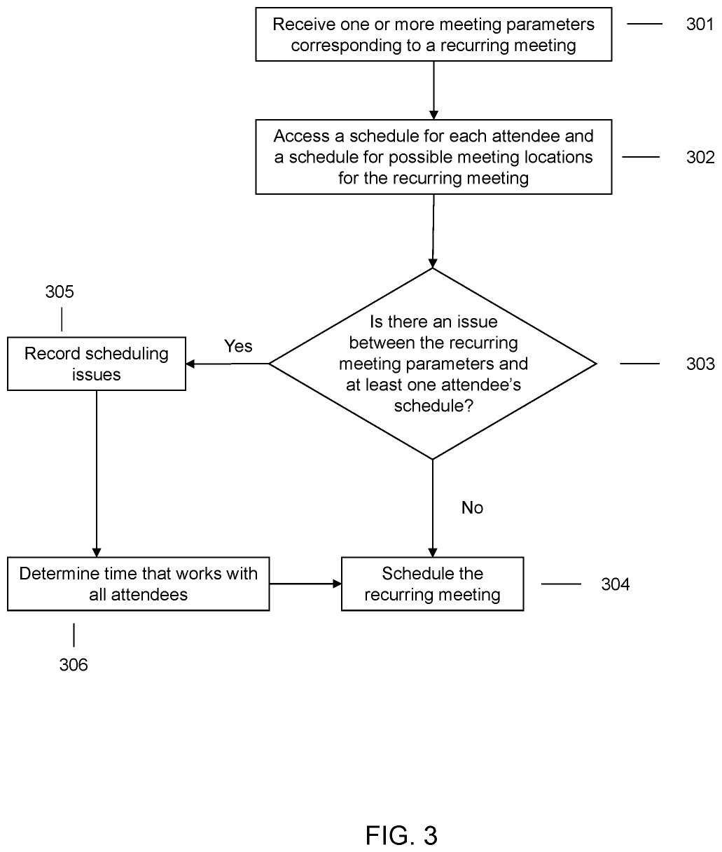

Referring now to FIG. 3, an embodiment may utilize a digital organization program to successfully schedule recurrences for recurring meetings for attendees while taking into account an attendees' schedules, a location availability schedule, and any additional input information that may affect the scheduling of each recurrence of the recurring meeting. At 301, an embodiment may receive one or more meeting parameters corresponding to a recurring meeting. Meeting parameters may include attendees, meeting location attributes (e.g., amenities, equipment, location with respect to other rooms, etc.), meeting location, meeting length, meeting time, meeting room capacity, and any other parameters that may affect a meeting time or location. In an embodiment, the meeting parameter information may be received at any type of information handling device. Throughout this application, mechanical user input (e.g., selection using a keyboard, including a soft keyboard, selection utilizing a mouse or other selection device, etc.) into a device may be commonly discussed; however, it is important to recognize other forms of input for different types of information handling devices may also utilize the methods discussed herein. For example, audible input associated with a hands-free device may be utilized to provide input for scheduling a recurring meeting.

In an embodiment, a system may require a user to input information or parameters regarding a desired meeting. In other words, a user may input information into a system describing the desired windows for a potential meeting to occur. Input information may include a list of attendees to be included in the meeting, a desired meeting location, meeting start time, recurrence frequency, meeting length, and the like. While the system is described in connection with scheduling recurring meetings, it should be understood that the same system can be utilized to schedule a meeting that occurs a single time. However, the greatest benefit of the system occurs with use for the scheduling of a recurring meeting, or a meeting having more than one occurrence.

In an embodiment, the desired meeting parameters may be set by a user or may be parameters having some flexibility. For example, the user may want the meeting to a have a set starting time, but is okay with the each meeting recurrence being of a different duration or at a different meeting location. Thus, the desired meeting parameters may be broad allowing for a large amount of meeting scheduling flexibility, or more may be more specific resulting in a decreased level of flexibility.

As an example of broad or flexible meeting parameters, a user may identify five attendees, meeting before lunch, in the meeting room that is closest in location to the user's office, with the meeting recurring every three days, and the desired length of the meeting as one hour. As a user inputs this information into a device, a user may further determine how flexible the parameters are. For example, with respect to the attendees, a user may invite five total attendees, but may indicate that only three are required and the other two are optional. The user may also indicate which attendees are required or may indicate that three out of five are required but it does not matter which three.

The meeting time being described as before lunch is already broad, but a user may select a window of time as a preferred window of time and narrow the broad meeting time. For the meeting room, a user may have a desired meeting location but may broaden the parameter to any meeting room in the building. As for the recurrence time, rather than a meeting having to occur every three days, as desired, a window for recurrence may be utilized, such as meeting at least every four days and no more than every three days. This window of recurrence allows for, based on the example, the meeting to happen every three to four days rather than being constricted to three days. The length of the meeting may also be described using a window technique that defines a range of length of time that the meeting can be.

Flexible meeting parameters may permit a system to find meeting availabilities when conflicting schedules arise. Additionally, the user can provide a combination of specific and broad meeting parameters. For example, a user can identify preferred meeting parameters that are more specific and also define broader meeting parameters that are utilized only in the case of scheduling conflicts. The user may also identify meeting parameters which are not flexible and that are required, for example, a particular attendee, a particular meeting location attribute (e.g., capacity, location, amenity, etc.), or the like.

At 302, an embodiment may then access the schedules, or calendars, of each attendee identified for the recurring meeting. It should be understood that the system accesses the schedules for each of the attendees for each recurrence of the meeting. By accessing the schedules of each attendee, a system may work around these already established events included on an attendees' schedule, and may attempt to schedule a recurring meeting around them. Additionally, the system may access meeting location schedules that identify possible meeting locations and meetings currently scheduled for those locations.

Additionally, the meeting location schedules may include additional information or attributes describing or related to the meeting location, which may also be utilized as meeting parameters, for example, the capacity of the location, whether the location includes certain equipment (e.g., projector, telephone, whiteboard, smartboard, accessibility options, digital assistants, televisions, etc.), the location of the location with respect to other things (e.g., lunch room, auditoriums, etc.), other attributes of the meeting location, and the like. The user may also provide such parameters when providing input at 301. Availability of meeting locations may also influence the scheduling of a recurring meeting. Comparing the obtained attendee schedules meeting location schedules to the recurring meeting parameters provided by the user may produce potential times and locations for each recurrence of the recurring meeting to take place.

A system and method may provide a user with potential times and locations for each recurrence of the recurring meeting. Additionally or alternatively, a system may provide an indication to a user describing conflicts between the provided recurring meeting parameters and the schedules of the attendees, the available meeting locations, or other parameters. At 303, the system may determine if issues or conflicts between the obtained schedules, meeting location availability and the user inputted recurring meeting parameters are present when attempting to schedule each recurrence of the meeting. In an embodiment, when conflicts between schedules and parameters are present, a system may record the scheduling issues, at 305, and provide the scheduling issues to the user, along with potential meetings that may work based on the flexible meeting parameters. In an embodiment, a user may then determine, at 306, which of the potential meetings having the flexed meeting parameters they would like to schedule, or may adjust a variable meeting parameter in an attempt to overcome scheduling issues. For example, the system may provide two potential meetings where one option has the meeting occurring at a meeting location in a different building and another option has the meeting occurring at a time different than the desired time.

In an embodiment, a system may utilize techniques to record the scheduling issue and determine potential meetings without additional user input. Rather than relying on user input to determine whether or not to schedule a meeting that falls within the flexible meeting parameters, a system may be programmed to schedule a meeting based on preferred parameters. For example, a system may be setup to schedule the recurring meeting with the least amount of deviation from the provided parameters. The user may also identify which parameters are the most important or have the highest priority. Thus, when a system produces multiple potential meetings that may fall within the flexible recurring meeting parameters, the recurrence for the meeting may be scheduled matching or most closely matching the parameters with the highest priority and the parameters having a lower priority are deviated from. In other words, a user may choose which meeting parameter or parameters a system may focus on when determining the most appropriate meeting time and location. The system may also use historical information when selecting parameters for meeting recurrences. For example, if the user has provided input selecting previous recurrences and those inputs include a pattern or some indication of parameter priority, the system may learn from these inputs to schedule subsequent recurrences having the same parameter priorities.

Once a system has identified a meeting time and location that falls within the parameters, either because no conflict or issue occurred while scheduling a recurrence at 303, or because the system has identified an acceptable deviation from the parameters at 306, the system may schedule the meeting at 304. It should be understood that some recurrences of the meeting may have no conflict or issues with the parameters, while other recurrences will have conflicts or issues. The described system is able to schedule each recurrence of the meeting utilizing the method described herein. Additionally, if no conflicts are identified, the system may automatically schedule the recurrences that do not have conflicts and then provide a list of recurrences that do have conflicts to the user, get user input with respect to the conflicts, and then schedule the conflicted recurrences based upon the user input. Alternatively, as discussed above, the system may automatically resolve the conflicts and then schedule the conflicted recurrences.

In an embodiment, after a meeting time and location are established, a system may schedule the meeting for each attendee. In other words, the meeting information may be added to all attendees' calendars and the meeting location calendar so that other events are not scheduled for that location during the recurring meeting time. During this scheduling, potential meeting locations and potential meeting times for all of the meetings for a set of recurring meetings may be provided to each attendee, including the user. Since the system may be scheduling recurring meetings around established events already present in attendee schedules, all the information, including information associated with future recurring meetings, may be provided. In an embodiment, future recurring meetings may adjust from the time they are originally provided to attendees up until the meeting start time. This may occur if an attendees schedule changes or if a meeting location may be needed for another event on short notice. In other words, the system can automatically change meeting parameters for a recurrence based upon receiving additional input after the recurrence has been scheduled.

In an embodiment, the recurring meeting may not occur within the same parameters as the previous meeting. In an embodiment, at least two meetings associated with a recurring meeting may be at radically different times and locations. For example, if a first meeting of a reoccurring meeting is held at 1:00 PM on Thursday in conference room #1 and has a desired length of one hour, but next week two of the attendees will be out of town on Thursday and Friday, the recurring meeting the following week may not be able to be held on the next Thursday. This may result in the meeting being held on Wednesday or earlier in the week depending on the recurring meeting parameters originally provided when creating the recurring meeting. To continue the example, two weeks from Thursday all of the attendees may be back in the office, and the recurring meeting may be moved back to Thursday rather than occurring on Wednesday again. An embodiment permits a system to adjust recurring meeting parameters to account for and overcome potential scheduling issues.

The various embodiments described herein thus represent a technical improvement to conventional methods for scheduling recurring meetings. Using the techniques described herein, an embodiment may automatically adjust the parameters surrounding a meeting to account for scheduling issues between attendees and meeting locations. In an embodiment, a user may input desired recurring meeting parameters along with flexible meeting parameters that may be used by the system to adjust the desired recurring meeting parameters. Responsive to identifying at least one potential instance where attendees may attend a recurring meeting, scheduling information may be provided to each attendee and the user. The adjustments to recurring meetings may be made up until the start time of a meeting to account for scheduling issues, and may include the least amount of deviation as possible from the desired recurring meeting parameters initially inputted by a user. Such an embodiment negates the conventional need of spending excessive time researching and creating meetings in an attempt to avoid scheduling conflicts.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, one or more meeting parameters corresponding to a recurring meeting and provided by a user;
accessing a schedule for each of a plurality of attendees and a schedule for possible meeting locations for the recurring meeting; and
based upon the one or more meeting parameters, the schedule for each of the plurality of attendees, and the possible meeting locations, scheduling times and locations for each recurrence of the recurring meeting.

2. The method of claim 1, wherein the one or more meeting parameters comprises a list of attendees for the recurring meeting.

3. The method of claim 1, wherein the one or more meeting parameters comprises one or more of: a meeting start time, a location, a recurrence frequency of the meeting, and a meeting length.

4. The method of claim 1, wherein the one or more meeting parameters comprise flexible parameters.

5. The method of claim 1, wherein the scheduling comprises scheduling different meeting times and locations for at least two of the recurrences of the recurring meeting.

6. The method of claim 1, wherein the scheduling comprises providing available meeting dates, available meeting times, and available meeting locations fulfilling the one or more meeting parameters.

7. The method of claim 1, wherein the scheduling comprises providing an indication of conflicts with the one or more meeting parameters.

8. The method of claim 1, wherein the scheduling comprises scheduling times and locations for each recurrence of the recurring meeting, wherein the scheduled times and locations have the least deviation from desired times and locations provided by the user.

9. The method of claim 1, wherein the scheduling comprises optimizing the scheduling to fulfill as many of the one or more meeting parameters as possible.

10. The method of claim 1, wherein the scheduling comprises automatically scheduling each recurrence of the recurring meeting without additional user input to address one or more conflicts identified by the information handling device during the scheduling.

11. An electronic device, comprising:
a wireless charger integrated into the electronic device;
a processor;
a memory device that stores instructions executable by the processor to:
receive, at an information handling device, one or more meeting parameters corresponding to a recurring meeting and provided by a user;
access a schedule for each of a plurality of attendees and a schedule for possible meeting locations for the recurring meeting; and
based upon the one or more meeting parameters, the schedule for each of the plurality of attendees, and the possible meeting locations, schedule times and locations for each recurrence of the recurring meeting.

12. The electronic device of claim 11, wherein the one or more meeting parameters comprises a list of attendees for the recurring meeting.

13. The electronic of claim 1, wherein the one or more meeting parameters comprises one or more of: a meeting start time, a location, a recurrence frequency of the meeting, and a meeting length.

14. The electronic device of claim 1, wherein the one or more meeting parameters comprise flexible parameters.

15. The electronic device of claim 1, wherein the scheduling comprises scheduling different meeting times and locations for at least two of the recurrences of the recurring meeting.

16. The electronic device of claim 1, wherein the scheduling comprises providing available meeting dates, available meeting times, and available meeting locations fulfilling the one or more meeting parameters.

17. The electronic device of claim 1, wherein the scheduling comprises providing an indication of conflicts with the one or more meeting parameters.

18. The electronic device of claim 1, wherein the scheduling comprises scheduling times and locations for each recurrence of the recurring meeting, wherein the scheduled times and locations have the least deviation from desired times and locations provided by the user.

19. The electronic device of claim 1, wherein the scheduling comprises optimizing the scheduling to fulfill as many of the one or more meeting parameters as possible.

20. A product, comprising:
a storage device that stores code, the code being executable by a processor and comprising:
code that receives one or more meeting parameters corresponding to a recurring meeting and provided by a user;
code that accesses a schedule for each of a plurality of attendees and a schedule for possible meeting locations for the recurring meeting; and
code that, based upon the one or more meeting parameters, the schedule for each of the plurality of attendees, and the possible meeting locations, schedules times and locations for each recurrence of the recurring meeting.
